(19) United States
(12) Patent Application Publication
(10) Pub. No.: US 2004/0101722 A1
(43) Pub. Date: May 27, 2004

(54) Fuel cell system with heat exchanger for heating a reformer and vehicle containing same

(76) Inventors: Ian Faye, Stuttgart (DE); Rainer Saliger, Freiberg (DE)

Correspondence Address: STRIKER, STRIKER & STENBY, 103 East Neck Road, Huntington, NY, 11743, US

(21) Appl. No.: 10/713,128

(22) Filed: Nov. 14, 2003

(30) Foreign Application Priority Data
Nov. 25, 2002 (DE) 102 54 842.0

(51) Int. Cl. H01M 8/06; H01M 8/04; B60L 11/18

(52) U.S. Cl. 429/20; 429/26; 180/65.3

(57) ABSTRACT

The fuel cell system has a combustion device (1, 24) with an exhaust gas line (3) for discharge of exhaust gas (7, 34), a reformer (20) for converting a fuel (6, 31) to a hydrogen-enriched fluid (35), a fuel cell unit (23) operating to produce electrical power from the hydrogen-enriched fluid (35) and air and a heat exchanger (2,WT1) arranged in the exhaust gas line (3). The heat exchanger (2, WT1) delivers heat of the exhaust gas (7, 34) to a heated fluid (32) for the reformer (20) and/or an operating substance (29, 30, 31) of the reformer (20).

### BACKGROUND OF THE INVENTION

1. Field of the Invention

The present invention relates to a fuel cell system with a combustion device, a fuel cell unit and a converter unit, designated “reformer” in the following, for converting a hydrocarbon-containing mixture, in the following designated “fuel”, to a hydrogen-containing or hydrogen-enriched fluid, in the following designated “reformate gas”, in which the combustion device has at least one exhaust line for discharge of exhaust gas.

2. Description of the Related Art

Vehicles provided with fuel cells and/or fuel cell stacks, especially which operate by means of a hydrogen-containing fluid produced “on-board”, as well as internal combustion engines have been known for a long time. The electrical energy produced by the fuel cell unit is used to supply electrical accessory units, such as a so-called auxiliary power unit (APU).

Frequently the hydrogen required by the fuel cell unit is produced “on-board” by autothermic reforming, steam reforming or partial oxidation of a hydrocarbon-containing fuel, e.g. gasoline, diesel fuel or natural gas, by means of a reformer. In autothermic reforming generally no additional heat is required, in steam reforming heat is supplied and in partial oxidation heat is released and must be dissipated or conducted away.

Generally heat energy must be supplied to the reformer in a starting stage, for example by means of an electric heater, in order to guarantee the required operating temperature for conversion of fuel with air oxygen. Additional water is required in this case depending on the reforming process selected, which is frequently heater and/or evaporated for that purpose.

In conventional systems the high electrical energy consumption or expense for heating the reformer and/or its operating substance is disadvantageous, especially during the starting stage.

### SUMMARY OF THE INVENTION

It is an object of the present invention to provide a fuel cell system with a combustion device, a fuel cell unit and a reformer for converting a fuel to a reformate gas for the fuel cell, wherein the combustion device has at least one exhaust gas line for discharge of exhaust gas, in which the additional needed energy required for heating the reformer is clearly reduced in comparison to that required for heating the reformer in conventional fuel cell systems.

It is also an object of the present invention to provide a vehicle, especially a self-propelled vehicle, containing the fuel cell system of this invention.

These objects and others, which will be made more apparent hereinafter, are attained in a fuel cell system with a combustion device, a fuel cell unit and a reformer for converting a fuel to a reformate gas, in which the combustion device has at least one exhaust line for discharge of the exhaust gas.

According to the invention the fuel cell system is characterized in that at least one heat exchanger for heating a separately heated fluid and/or an operating substance of the reformer with heat from the exhaust gas is arranged in the at least one exhaust line.

Further advantageous features and embodiments of the invention are set forth in the appended dependent claims.

The heat exchanger according to the invention utilizes the unused exhaust gas energy of the combustion device in an advantageous manner for an especially rapid and energetically propitious heating of the reformer and/or converter unit. In this case a separate electrical or comparable heating unit can be at least partially or completely dispensed with for this reason.

The temperature of the exhaust line rises to a comparatively high temperature after a comparatively short time, because of the high exhaust temperatures arising during combustion of the fuel in the combustion device. Its enthalpy can be delivered to the operating medium of the reformer and/or to a separately heated fluid for heating the reformer as needed by means of the heat exchanger.

If necessary the heat supplied to the reformer from the exhaust gas energy of the combustion device can take place by a nearly continuous operation of the heat exchanger. A transition from autothermic reforming to an endothermic reforming with comparatively higher hydrogen production efficiency can be realized. The intake and/or compression of air for the reforming process can thereby be decisively reduced and/or eliminated. The fuel cell system can advantageously be operated with higher operating pressures by so-called parasitic output of compressors or the like. Furthermore improved switching between autothermic reforming and steam reforming can take place according to the invention.

In a particularly preferred embodiment of the invention the heat exchanger is arranged near or immediately at an outlet opening of the combustion device. For example the heat exchanger is arranged on a so-called exhaust manifold. The exhaust gas line is especially hot and/or comparatively rapidly heated in the immediate vicinity of the outlet opening of the combustion device, so that the reformer or converter unit can be heated correspondingly rapidly and/or strongly. Thus a comparatively large amount of heat can be delivered to the reformer or converter unit.

Preferably the operating substance for the converter unit that is to be heated at least partially comprises the hydrocarbon-containing mixture, air and/or water. Thus the converter unit can be heated up from the interior or directly on the catalytically active reactor surfaces of the converter unit, so that the starting stage and/or the heating up to operating temperature of the converter unit advantageously takes place comparatively rapidly and sufficiently energetically.

In a special embodiment of the invention at least one metering element for metering or regulation of the flow of the operating substance and/or heated fluid is provided. An advantageous control and/or regulation of heat up of the converter unit is accomplished with the help of this feature. Changing the mass flow of the operating substance to be heated by means of a regulator valve, pump, additional heat exchanger or the like, results in a controlled heat up of the converter unit.

For example, a preferred heat exchanger manifold can be arranged and/or flanged on the generally metal exhaust gas manifold, so that especially multiple operating substances and/or at least one operating substance and separately heated fluid for receiving the exhaust energy can nearly simultaneously flow through the heat exchanger. Thus an especially advantageous interior and/or exterior heat up of the converter unit can take place.

Preferably at least one exhaust gas catalytic converter is provided for exhaust gas purification. For example an already commercially available so-called catalytic converter can be used for this purpose. A reduction of the environmentally relevant exhaust gas emissions can thus be provided in the fuel cell system according to the invention.

In a preferred embodiment of the invention the catalytic converter for gas purification is arranged downstream of the heat exchanger. This feature helps to guarantee that the exhaust gas flowing to the catalytic converter for exhaust gas purification is cooled by delivering heat to the at least one heat exchanger. Thus overheating of this exhaust gas purifying device, especially during comparatively high load and/or in the full load range of the combustion device, is avoided. The service life or lifetime of the catalytic converter for exhaust gas purification can advantageously be extended and/or improved by reducing the thermal load on it.

Furthermore a so-called full load enrichment, as currently usually employed in current gasoline motors, can be eliminated, so that the otherwise increased fuel consumption, because of the supply of additional fuel and/or operating mixture for exhaust gas cooling in full load operation can be eliminated. Correspondingly an especially environmentally friendly operation of the combustion device and/or the vehicle according to the invention is realized.

Preferably the catalytic converter for exhaust gas purification is arranged in the vicinity of the heat exchanger. For example, the heat transfer by means of the at least one heat exchanger can be largely halted by an advantageous control device in order to attain operating temperature of the catalytic converter for gas purification, i.e. until the so-called cat-light-off state is reached. This operating temperature is rapidly reached when the catalytic converter and the heat exchanger are arranged comparatively close to each other. The so-called cat-light-off state is thus decisively speeded up, so that especially clearly less environmentally relevant exhaust gas emissions are produced during the starting stage of the combustion device and/or the exhaust gas purifying device associated with it.

In a preferred embodiment of the invention at least one storage unit or reservoir is provided for storing reformate gas. A temporary decoupling of the hydrogen production and the hydrogen utilization can be attained with the help of a suitable storage unit. For example the combustion device, above all, during the starting stage can be operated nearly exclusively with the reformate gas, whereby an especially drastic lowering of the environmentally relevant exhaust gas emissions is achieved.

If needed, the combustion device can be operated in a mixed operation in the starting stage. That means that both conventional fuel and reformate are burned in the combustion device.

Furthermore an accelerated cat-light-off state can be attained by a so-called rich operation of the combustion device, i.e. with hydrogen excess, and in this case a secondary air feed. Hydrogen, which is exothermally reacted on suitable catalytically active surfaces at room temperature, is partially not reacted in the combustion device and is present in the exhaust gas, so that the catalytic converter or exhaust gas purification device is comparatively rapidly heated up. This provides an especially strong and/or rapid heating up of the exhaust gas purification device is achieved. Accordingly this can also be accomplished without secondary air supply by a mixed rich/lean operation distributed over the individual cylinders.

A definite increase in the exhaust gas feedback rate (AGR rate) in comparison to pure fuel or gasoline operation can be achieved in an advantageous manner with the help of a mixed operation of the combustion device, for example with a mixture of fuel and reformate gas. A suitably high exhaust gas feedback rate caused by choking of the motor and/or combustion device leads to a definite increase in efficiency and thus to a special lower total fuel consumption for the vehicle. A suitably high exhaust gas feedback rate is especially adjustable because of the comparatively large ignition range of hydrogen in comparison to that of gasoline.

In a preferred embodiment of the fuel cell system at least one heat reservoir for storing heat is provided. For example, a latent heat reservoir or the like for delivery of stored heat is arranged in thermal contact and/or connected thermally by means of an advantageous fluid to the exhaust gas catalytic converter, to the reformer, to the fuel cell unit and/or other components of the fuel cell system. These components, which have at least partially a catalytically active reaction surface, are supplied comparatively rapidly with heat of a heat reservoir according to the invention. The heat is supplied and/or transferred in this case from the combustion device and/or other components generating heat by means of at least one heat exchanger and/or the appropriate fluid or the heat reservoir.

For example, a heating unit, an exhaust gas line, an exhaust gas heat exchanger, an especially catalytically active burner and/or the fuel cell unit, are used as the components of the fuel cell system generating heat. The heat reservoir according to the invention can, among other things, receive heat energy from one of the components producing heat in a certain heat-releasing phase. Generally it is temporarily disconnected from the heat-supplying component in a heat-consuming phase in which it supplies and/or feeds back heat to one and/or more suitable components.

In a special embodiment of the invention a heat-storing material of the heat reservoir undergoes a phase change and/or changes phase within an operating temperature range, especially a solid-liquid phase change. Preferably a so-called PCM (phase changing material) is used as the heat-storing material and is integrated into the heat cycle of the fuel cell system.

The solvation enthalpy, the melting enthalpy and/or the evaporation enthalpy of the heat-storing material according to the invention can be used, so that especially a comparatively space-saving and/or compact heat reservoir according to the invention is realized with comparatively great heat storing capacity. Salts and/or salt solutions known already for this purpose can be used in this case.

### BRIEF DESCRIPTION OF THE DRAWING

The objects, features and advantages of the invention will now be illustrated in more detail with the aid of the following description of the preferred embodiments, with reference to the accompanying figures, in which

FIG. 1 is a diagrammatic cross-sectional view of parts of a fuel cell system according to the invention with an internal combustion engine and a heat exchanger; and

FIG. 2 is a flow diagram of a fuel cell system according to the invention.

### DETAILED DESCRIPTION OF THE INVENTION

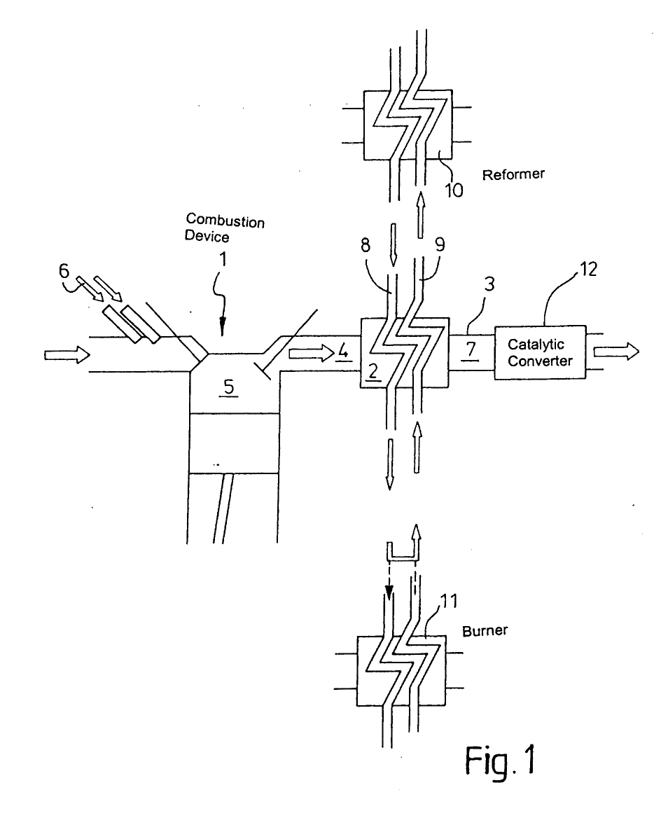

FIG. 1 shows an internal combustion engine 1 with a heat exchanger 2 according to the invention. The heat exchanger 2 especially is in the exhaust gas line 3, i.e. connected or flanged directly or as directly as possible on an outlet opening 4 of the internal combustion engine 1.

Generally a fuel-air mixture is burned in a combustion chamber 5 of the engine 1. Comparatively hot exhaust gas 7 is produced by the combustion.

According to the invention the heat energy of the exhaust gas 7 is used for heating the reformer 10 by means of the heat exchanger 2. The heat exchanger 2 especially has an inflow line 8 and an outflow line 9 for at least one operating substance and/or heating medium of the reformer 10.

Several heat exchanger mediums can flow through the heat exchanger 2 nearly simultaneously, generally spaced from each other, as needed. Alternatively a single operating substance and/or heating medium can be supplied to the heat exchanger 2 according to the operating state of the entire system.

For heating the reformer 10 and/or its operating substance a catalytic burner 11 can also be provided.

For example after the engine is started the internal combustion engine 1 is operated with reformate gas from a reservoir that is not shown in FIG. 1 and for that reason emits scarcely any environmentally relevant exhaust gas 7. The operation with hydrogen, especially without any noteworthy heat loss by the heat exchanger, leads, above all, to a comparatively rapid reaching of the operating temperature of the exhaust gas catalytic converter 12. The amount of reformate until reaching a so-called cat-light-off state is comparatively small and can be made available, among other ways, by supplying it from a pressurized reservoir.

Preferably fuel 6 or a mixture of fuel and reformate gas 6 is preferably used to operating the internal combustion engine 1 immediately after reaching the cat-light-off state. A comparatively higher temperature is thereby rapidly produced in the exhaust gas line 3. One and/or all operating substances and/or a separately heated fluid of the reformer can be heated up because of the comparatively high temperatures of the exhaust gas line 3. The reformer is heated comparatively rapidly to the operating temperature and is thus ready to generate reformate and/or hydrogen required for an unshown fuel cell unit. Reformate and/or the hydrogen is temporarily stored in this case at the operating pressure and supplies the engine 1 and/or the fuel cell unit during the next system start.

Generally the hydrogen and/or reformate reservoir or tank required for self-sufficient fuel cell vehicles is reduced or eliminated by the combination of the internal combustion engine 1 with the fuel cell system. Similarly reduction of the filling pressure of the reservoir or tank and thus a simplification of the reformer is possible because of the lower required operating pressure.

For example, hot vapor or steam is available for operating an autothermic reformer by means of the heat exchanger 2 according to the invention. Alternatively comparatively smaller or no water can be fed to the reformer also in a starting stage, so that the heat energy required during the starting stage is clearly reduced. In the latter case for example the fuel 6 can be evaporated and the catalytically active reformer can be heated. The conversion of the fuel 6 on the catalytically active surfaces occurs in this case generally with air oxygen, so that heat is released and the heating stage is accelerated again.

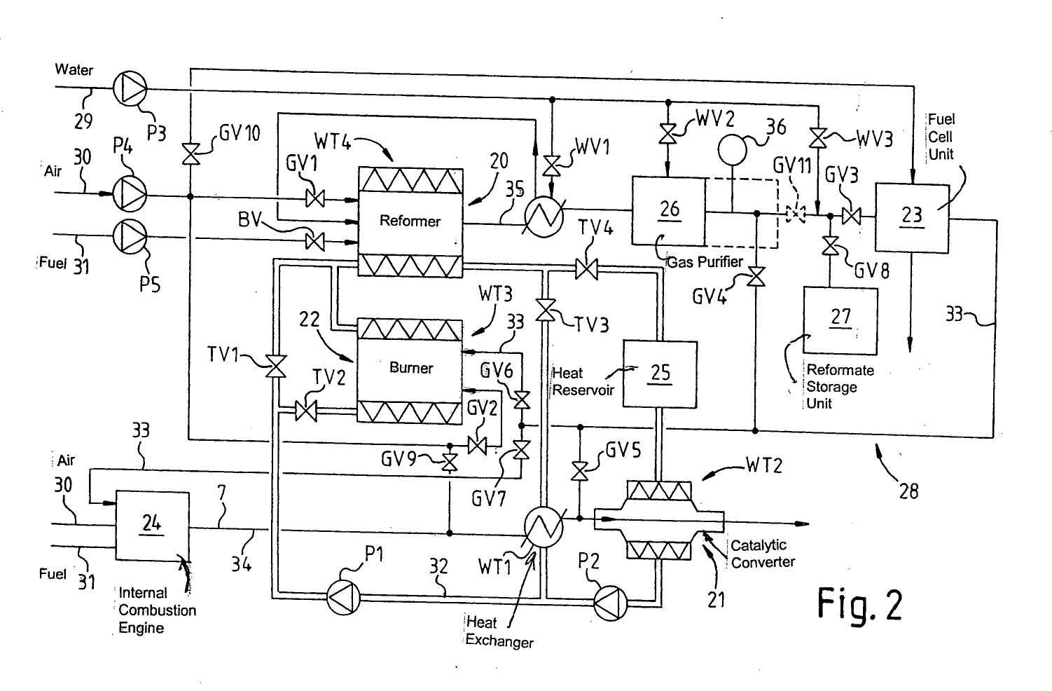

For improved concrete illustration of the control and operation explained above a particular embodiment of the fuel cell system according to the invention is shown in FIG. 2. Individual typical operating states together with suitable switching of control valves are described in further detail in the following description.

Operating state 1: A reformer 20 and an exhaust gas catalytic converter 21 are cold. A different procedure for starting an internal combustion engine 24 can be hereby performed. For example, in case a) latent heat reservoir (PCM) 25 is largely filled, so that it can be drawn on for the rapid and sufficient pre-heating of the exhaust gas catalytic converter 21.

A pump P2 circulates a thermofluid 32 in a thermo-circulation of the fuel cell system, in which thermo-valves TV3, TV4 are open and thermo-valves TV1, TV2 are closed, until an operating temperature (T_{akat, set}) of the exhaust gas catalytic converter 21 is reached. Generally the engine 24 is subsequently started.

For this purpose, among others, unshown temperature sensors are preferably placed in the latent heat reservoir 24 and in the exhaust gas catalytic converter 21.

In a second case b) e.g. reformate reservoir 27 is provided and at least partially filled, wherein the heat reservoir 25 is provided with an insufficient amount of heat or with no heat during case a).

Gas valves GV8, GV4, GV5, GV11 are open for the combustion gas and/or reformate gas 35. Preferably a fan P4 is started and a gas valve GV9 is opened for the air supply to the exhaust gas catalytic converter 21. The air oxygen reacts with the hydrogen H₂ present in the reformate gas 35, so that heat is released for heating the catalytic converter 21 in an advantageous manner by means of the catalytically active coating of the catalyzer 21 and it is heated comparatively rapidly. As soon as the operating temperature T_{akat, set} of the exhaust gas catalytic converter 21 is reached, the internal combustion engine 24 is started.

Further the gas valves GV5, GV9 are closed and the gas valves GV2, GV6 are similarly opened besides the already opened gas valves GV11, GV4. Air oxygen is again hereby supplied with reformate hydrogen to a catalytically active burner 22, so that heat is released as a support for the heating of the reformer.

Alternatively or in combination therewith gas valves GV3 and GV10 are opened and gas valves GV11 and GV4 are preferably closed so that a fuel cell unit 23 and/or a fuel cell stack 23 can be started. That means that the operation of the fuel cell unit 23, especially for a transient time interval 27, above all, occurs from the reformate reservoir 27. Generally anode residual gas is conducted to the catalytically active burner 22 via the gas valve GV6.

According to case c), especially the reformer 20 is started first, so that the conventional cases a) and b) do not result. For this purpose a gas valve GV1 for supply of air and a gasoline valve BV for supply of gasoline or another hydrocarbon material, such as diesel fuel, natural gas, etc, are opened. The fan P4 and the fuel pump P5 are preferably operated to provide a comparatively reduced pressure. Preferably the gas valves GV6, GV7, GV11 remain closed and the gas valves GV4, GV5, GV9 are opened, so that the exhaust gas catalytic converter 21 can be heated by means of air oxygen and hydrogen-containing or hydrogen-enriched reformate 35.

The gas valve GV5 closes, especially when the temperature of the catalytic converter 21 Tₐₖₐₜ>T_{akat, set} is reached, so that the internal combustion engine 24 can be started. Subsequently the valves GV6 and GV7 open, according to the temperature of the reformer 20 and/or with needed adding of reformate 35 to the internal combustion engine 24.

The ratio of respective gas flow rates to the internal combustion engine 24 and to the reformer is arbitrarily selectable by suitable control and/or partial opening and/or closing of the participating valves.

Preferably the gas valve GV5 opens also during operation, when the exhaust gas catalytic converter temperature drops under the set value T_{akat, set}.

Generally the reformer 20 can also be started according to case c), when the internal combustion engine 24 is already started. Preferably in that case thermo-valves TV4, TV1 are closed herewith. An especially rapid heating of the reformer 20 is achieved by opening thermo-valves TV2, TV3.

The thermofluid 32 picks up heat for the catalytically active burner 22 by means of a heat exchanger WT1 in this circulation, e.g. before it reaches the reformer 20, thus also cooling the internal combustion engine 24. Heat exchangers WT3, WT4 are provided for transferring heat from the thermofluid 32 to the burner 22 and/or the reformer 20.

Air 30 and a fuel 31 or gasoline 31 fed to reformer 20 react exothermically to produce heat in addition to the heating of the reformer by thermofluid 32.

For example for switching the reformer 20 from a partial oxidation (POX) to a steam reforming process (STR), as soon as the threshold temperature T_{ref, set 1} is reached in reformer 20, generally water valve WV1 is opened to supply metered amounts of water 29. A gas purifier 26 can be provided, as needed. Also a water valve WV2 is connected with it and is opened in the above-mentioned switching to supply it with water.

In an advantageous manner the reformer temperature should not drop below a second threshold temperature T_{ref, set 2}, wherein T_{ref, set 2}<T_{ref, set 1}. Preferably during the metering of water a CO concentration meter 36 should be almost continuously operated to measure CO concentration of the gas output from the gas purifier 26. As long as the CO concentration is greater than a set value COₛₑₜ, gas valve GV11 generally remains closed.

Furthermore in this operation stage gas valve GV5 and similarly gas valve GV7 are closed for as rapid as possible a heating of the reformer 20. Preferably a gas valve GV6 is open to the burner 22. The opening of the gas valve GV5 has already been described above.

With a reformer operating by a membrane separation method, i.e. without the gas purifier stage formed as a shift and/or oxidation stage, a retentate or residue containing a comparatively reduced amount of hydrogen is continuously conducted through gas valve GV4. Furthermore the gas valves GV3 and/or GV8 are opened for a permeate 35 containing a very high amount of hydrogen and/or for the hydrogen passing through the membrane, preferably according to the filling state of the reformate reservoir 27 and the electrical current production and/or of the energy needs of the fuel cell unit 23. The amount of the permeate 35 is frequently comparatively small in this operation stage. The valve GV11 especially can be eliminated when a membrane reactor is used.

The transition to current production in the fuel cell unit 23 from the reformate 35 of the reformer 20 with gas purification stage 26 preferably takes place as soon as the CO concentration 36 drops below the threshold value COₛₑₜ, above all by increasing the water content. During this change the gas valve GV4 is closed and the gas valve GV11 is opened. Either the valve GV3 and/or the valve GV8 are switched to conducting depending on the filling state of the reformate reservoir 27 and the electrical power requirements of the fuel cell unit 23.

The adjustment of the pump power of pump P1 and the mutual positions of the valves GV6 and GV7 takes place in hot operation of the internal combustion engine 23 and the reformer 20, preferably as a function of the heat requirements of the reformer 20 and the required extent of admixing of the internal combustion engine 24.

The transition to the high-pressure range for a membrane separation method takes place, especially as soon as sufficient heat is supplied to the reformer 20 by means of the thermofluid 32 from the exhaust gas heat exchanger WT1 and the burner 22. When the reformer 20 is controlled at the set temperature T_{ref, 3}, the airflow 30 into the reformer 20 can be cut off, above all, by gradual closing of the gas valve GV1. The energy for endothermic steam reformation is provided primarily in this case by the thermofluid 32 alone. The pumps P3, P5 can act on the water 29 and gasoline 31 with higher pressures, e.g. between 10 and 20 bar, in an advantageous manner. The valve GV4 functions here especially as a pressure-maintaining valve. Hydrogen can permeate the unshown membrane in large amounts according to it and arrive at the fuel cell unit 23 through the opening valve GV3.

Operating state 2: The internal combustion engine 24 is not started and a power supply independent operation of the fuel cell unit 23 is provided.

The reformer 20 is preferably first heated up by partial oxidation, assisted by heat, which originates from reaction of CO rich reformate gas and/or retentate from the unshown metal and/or plastic membrane in the catalytic burner 22. Valves GV1, GV4, GV6 are opened and a gradual increase of the vapor components is realized in the reformer 20 by opening of the valve WV1, until the required heat for reforming can be provided, especially by the burner 22. Furthermore the valves GV6, GV2 are opened.

Subsequently a gradual shutting off and/or reduction of the air and/or its components is performed, so that a nearly purely steam reforming (STR) occurs at comparatively high pressure in which the valve GV4 is used as a pressure regulating valve.

Preferably at comparatively high pressures larger amounts of hydrogen-permeate and/or reformate gas 35 purified by CO flow through the open valve GV3 into the fuel cell unit 23 and can be converted into electrical current. When membrane methods are used for purification of reformate 35, the valve GV11 can be eliminated.

The fuel cell unit 23 can be supplied with hydrogen-enriched fuel 35 by the reformate reservoir 27 to pass by the starting time of the reformer 20, in so far as it is filled. As already mentioned, the anode residual gas 33 as needed together with the hydrogen-containing retentate is conducted from the membrane unit into the burner 22, while the valve GV6 is open and the valves GV5, GV7 are closed.

Operating state 3: The heat operation of the internal combustion engine 24 and exhaust gas catalytic converter 21 takes place in operating state 3. In order to prevent damage to the exhaust gas catalytic converter 21, the exhaust gas temperature of the internal combustion engine 24 should not be too high at the exhaust gas catalytic converter 21. Temperatures at the outlet of the engine can reach 700° C. in certain load conditions of the engine. A heat exchanger WT1 is provided in the exhaust gas train 34 to bear and/or reduce these comparatively high temperatures. The control of the cooling agent flow 32 through the heat exchanger WT1 is realized with the aid of the pump P1, especially as a function of the exhaust gas catalytic converter temperature. The high exhaust gas temperatures can be made useable for the reforming reaction by means of the thermofluid 32. The burner 22 can provide additional heat. The reforming performance is modulated in an advantageous manner also as a function of the available heat in the heat circulation and the burner 22.

Heat can advantageously be supplied by means of the valve TV4 to the heat reservoir 25 with sufficient temperatures in the thermofluid 32 at the outlet of the reformer 20 and in the case of a partially empty heat reservoir 25.

A comparatively ineffective change to autothermal reformation is also conceivable in hot operation of the reformer 20 by supplying air 30 to the reformer 20 with too little heat for current production required of the fuel cell unit 23, especially for process embodiments with gas purification 26. In this case short current peaks are advantageously smoothed by the power supply and/or with the help of the reformate reservoir 27.

Temperature peaks and/or excessive temperatures of the thermofluid 32 at the entrance to the reformer 20 can preferably be borne by partially opening a bypass by means of the valve TV1 as needed, preferably for a short time interval. Excess heat at the reformer outlet can possibly be used to supply the heat reservoir 25 by opening the valve TV4.

Above all, in the case that excess heat is present in thermofluid 32, and/or that heat present is otherwise not required in the system, at least a part of the unnecessary anode residual gas 22 can be conducted into the internal combustion engine 24, instead of into the burner 22. A special emission poor mixed operation is realized because of these measures. Generally a special emission-poor operation of the internal combustion engine 24 and/or the corresponding vehicle is possible by means of a suitable mixed operation.

Moreover advantageous catalyzer regeneration with the anode residual gas is conceivable, e.g. for NOₓ-reservoir catalyzers, particle filters and/or their regeneration or the like.

Basically according to the invention an advantageous variable switching between supplying heat to the exhaust gas catalytic converter 21 and the reformer 20 takes place. The heat reservoir 25 is of especially great advantage because of the timely decoupling of heat generation and heat demands.

A second pump P2 can be optionally provided. For example, above all, the thermofluid 32 can be supplied or pumped through the heat reservoir 25 with the valves TV1, TV2 closed. This is conceivable especially in the case that the reformer 20 is not in operation, for example in a starting stage in which only the exhaust gas catalytic converter 21 is heated in an advantageous manner. Possible heat losses of the system are largely minimized because of this feature. The pump P2 can be dimensioned smaller in comparison to the pump P1.

Generally when the reformer 20 is started partial oxidation for cold start and/or the autothermal reforming is preferred. The steam reforming provides a higher hydrogen yield with external heat supplied and thus greater current production efficiency. Also the latter process permits the advantageous realization of an effective membrane separation method without the otherwise inherent large power losses by air compression.

Furthermore different concepts exist for gas purifier 26 to minimize the CO concentration (sensor 36) in the reformate gas 35. Especially the separation of hydrogen H₂ with a metallic semipermeable membrane in regard to volume and weight is preferred for the multi-stage shift stage 26 and the selective oxidation 26. A PEM fuel cell 23 is frequently advantageous in comparison to a SOFC 23.

Basically the total efficiency is clearly improved by using exhaust gas energy by one or more heat exchangers WT1, WT2, WT3, WT4. The electrical heating of the catalytically active components 20, 21, 22, 26 with the required separating heating devices necessary for that purpose can be reduced or eliminated by the use of the exhaust gas energy. Also the service life is considerably increased by the improved thermal operation conditions for the exhaust gas catalytic converter 21.

As already described in the description of the state of the art, future driving concepts based on a fuel cell drive either with or without the reforming processes have attained increasing importance. Besides that fuel cells 23 are used for power supply systems. The regulating strategy used very strongly affects the amalgamation of the internal combustion engine requirements, the requirements of reforming and the optimum integration of both systems in regard to efficiency. Especially with the help of the above-described control and/or regulation strategy the efficiency of appropriate fuel cell systems are considerably improved in relation to prior art fuel cell systems.

The term “hydrocarbon-containing mixture” means a mixture comprising hydrocarbons. The term “hydrogen-enriched fluid” means a fluid containing hydrogen or enriched with hydrogen (in comparison to a starting fluid).

The fuel cell unit 23 in the embodiment shown is a unit that produces electric power from reformate 35 or a hydrogen-enriched fluid and oxygen, especially air containing oxygen.

The disclosure in German Patent Application 102 54 842.0 of Nov. 25, 2002 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a fuel cell system, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A fuel cell system comprising
a combustion device (1, 24) having at least one exhaust gas line (3) for discharge of exhaust gas (7, 34),
a reformer (20) for converting a hydrocarbon-containing mixture (6, 31) to a hydrogen-enriched fluid (35),
a fuel cell unit (23), and
at least one heat exchanger (2,WT1) arranged in the at least one exhaust gas line (3), said at least one heat exchanger (2, WT1) comprising means for delivery of heat from said exhaust gas (7, 34) to a heated fluid (32) and/or an operating substance (29, 30, 31) of the reformer (20).

2. The fuel cell system as defined in claim 1, wherein said combustion device (1, 24) has an outlet opening (4) for said exhaust gas (7, 34) and said at least one heat exchanger (2, WT1) is arranged in the vicinity of the outlet opening (4) for said exhaust gas.

3. The fuel cell system as defined in claim 1, wherein said operating substance (29, 30, 31) of said reformer (20) to be heated comprises said hydrocarbon-containing mixture (6, 31).

4. The fuel cell system as defined in claim 1, wherein said operating substance (29, 30, 31) of said reformer (20) to be heated comprises air.

5. The fuel cell system as defined in claim 1, wherein said operating substance (29, 30, 31) of said reformer (20) to be heated comprises water (29).

6. The fuel cell system as defined in claim 1, further comprising at least one metering element (BV, TV, WV) for metering or regulating a flow of said operating substance (29, 30, 31) and/or said heated fluid (32).

7. The fuel cell system as defined in claim 1, further comprising at least one exhaust gas catalytic converter (21) for purifying said exhaust gas.

8. The fuel cell system as defined in claim 7, wherein said at least one exhaust gas catalytic converter (21) is arranged downstream of the said at least one heat exchanger (2, WT1) in a flow direction of said exhaust gas (7, 34).

9. The fuel cell system as defined in claim 1, further comprising at least one storage unit (27) for storing said hydrogen-enriched fluid (35).

10. The fuel cell system as defined in claim 1, further comprising at least one heat reservoir (25) for storing heat.

11. The fuel cell system as defined in claim 10, wherein said heat reservoir (25) comprises a heat-storing material and wherein said heat-storing material undergoes a phase change in an operation stage.

12. A vehicle comprising a combustion device (1, 24) having at least one exhaust gas line (3) for discharge of exhaust gas (7, 34) and a fuel cell system; wherein said fuel cell system comprises said combustion device (1, 24) with said at least one exhaust gas line (3), a reformer (20) for converting a hydrocarbon-containing mixture (6, 31) to a hydrogen-enriched fluid (35), a fuel cell unit (23) and at least one heat exchanger (2,WT1) arranged in the at least one exhaust gas line (3), said at least one heat exchanger (2, WT1) comprising means for delivery of heat from said exhaust gas (7, 34) to a heated fluid (32) and/or an operating substance (29, 30, 31) of the reformer (20).

13. The vehicle as defined in claim 12, consisting of a self-propelled vehicle.

14. The vehicle as defined in claim 13, wherein said combustion device (1, 24) comprises an internal combustion engine have a plurality of cylinders and said fuel cell unit (23) produces electrical power from air and said hydrogen-enriched fluid (35).
